(19) United States
(12) Patent Application Publication
(10) Pub. No.: US 2024/0408549 A1
(43) Pub. Date: Dec. 12, 2024

(54) WATER TREATMENT CHEMICAL AND WATER TREATMENT MEMBRANE

(71) Applicant: NIPPON SHOKUBAI CO., LTD., Osaka-shi, Osaka (JP)

(72) Inventors: Yasuyuki MIYOSHI, Osaka (JP); Hiroyasu WATABE, Osaka (JP)

(21) Appl. No.: 18/697,980

(22) PCT Filed: Sep. 26, 2022
(86) PCT No.: PCT/JP2022/035684

§ 371 Date: Apr. 2, 2024

(30) Foreign Application Priority Data
Oct. 6, 2021 (JP) 2021-164608

(51) Int. Cl. B01D 65/08; B01D 71/40; C02F 1/44

(52) U.S. Cl. CPC B01D 65/08; B01D 71/401; C02F 1/44; B01D 2325/28

(57) ABSTRACT

The present invention aims to provide a water treatment chemical that can impart good water permeability and good water permeability retention to a water treatment membrane. The present invention relates to a water treatment chemical containing a polymer that contains a structural unit (I) represented by a formula (1) and a structural unit (II) derived from a carboxy group-containing monomer. The formula (1) is represented by the following formula:

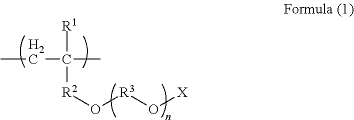

wherein R¹ is a hydrogen atom or a methyl group; R² is a direct bond, —CH₂—, —CH₂CH₂—, or —CO—; R³s are the same as or different from each other and are each a C1-C20 alkylene group; X is —CH₂CH(OH)CH₂(OH) or —CH(—CH₂OH)₂; and n is a number of moles of oxyalkylene groups added and is 0 to 100.

### TECHNICAL FIELD

The present invention relates to a water treatment chemical and a water treatment membrane.

### BACKGROUND ART

Conventional water treatment membranes used to treat water containing impurities tend to be contaminated (fouled) with use, resulting in a decrease in permeate water flux. A known technique for preventing or reducing fouling is to subject water treatment membranes to hydrophilic treatment by bringing the water treatment membranes into contact with various types of hydrophilic resins.

For example, Patent Literature 1 discloses an antifouling ability-imparting agent containing a polymer that contains a structural unit represented by the following formula (1) and/or a structural unit represented by the formula (2).

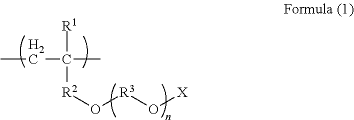

In the formula, R¹ is a hydrogen atom or a methyl group; R² is a direct bond, —CH₂—, —CH₂CH₂—, or —CO—; R³s are the same as or different from each other and are each a C1-C20 alkylene group; X is —CH₂CH(OH)CH₂(OH) or —CH(—CH₂OH)₂; and n is a number of moles of oxyalkylene groups added and is 0 to 100.

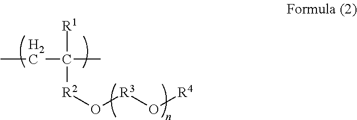

In the formula, R¹ is a hydrogen atom or a methyl group; R² is a direct bond, —CH₂—, —CH₂CH₂—, or —CO—; R³s are the same as or different from each other and are each a C1-C20 alkylene group; R⁴ is a hydrogen atom or a C1-C20 alkyl group; and n is a number of moles of oxyalkylene groups added and is 1 to 100.

### CITATION LIST

### Patent Literature

Patent Literature 1: JP 2019-42689 A

### SUMMARY OF INVENTION

### Technical Problem

The above-described known water treatment chemicals that effectively prevent or reduce fouling of water treatment membranes have room for further improvement in permeate water flux. In response, the present disclosure aims to provide a water treatment chemical that can impart good water permeability and good water permeability retention to a water treatment membrane.

### Solution to Problem

In order to achieve the above object, the present inventor has conducted various studies and reached the present invention. That is, the water treatment chemical of the present disclosure is a water treatment chemical containing a polymer that contains a structural unit (I) represented by a formula (1) and a structural unit (II) derived from a carboxy group-containing monomer. The formula (1) is represented by the following formula:

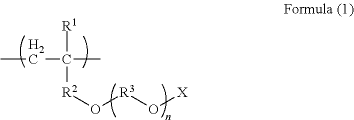

wherein R¹ is a hydrogen atom or a methyl group; R² is a direct bond, —CH₂—, —CH₂CH₂—, or —CO—; R³s are the same as or different from each other and are each a C1-C20 alkylene group; X is —CH₂CH(OH)CH₂(OH) or —CH(—CH₂OH)₂; and n is a number of moles of oxyalkylene groups added and is 0 to 100.

### Advantageous Effects of Invention

The water treatment chemical of the present disclosure can impart good water permeability and excellent water permeability retention as well as antifouling function to a water treatment membrane.

### BRIEF DESCRIPTION OF DRAWINGS

FIG. 1 shows a schematic view of a test apparatus for evaluating the antifouling ability in examples and comparative examples.

### DESCRIPTION OF EMBODIMENTS

The present invention will be described in detail below. Any combination of two or more of the following preferred embodiments of the present invention is also a preferred embodiment of the present invention.

### (Water Treatment Chemical of the Present Disclosure)

The water treatment chemical of the present disclosure contains a polymer containing a structural unit (I) represented by the formula (1) and a structural unit derived from a carboxy group-containing monomer (hereinafter also referred to as “a polymer of the present invention”).

The polymer of the present invention may contain one or more structural units corresponding to the structural unit (I) and one or more structural units derived from a carboxy group-containing monomer. In addition to these structural units, the polymer of the present invention may further contain one or more structural units derived from a sulfonic acid group-containing monomer and one or more structural units derived from a different monomer.

### <Structural Unit (I) Represented by Formula (1)>

The polymer of the present invention contains a structural unit (I) represented by the formula (1).

In the formula (1), R¹ is a hydrogen atom or a methyl group. R² is a direct bond, —CH₂—, —CH₂CH₂—, or —CO—. In terms of affinity for water treatment membranes, —CO— is preferred.

R³s are the same as or different from each other and are each a C1-C20 alkylene group. In terms of affinity for water treatment membranes, the number of carbon atoms of the alkylene group is preferably 1 to 10, more preferably 1 to 5, still more preferably 2 to 3.

The subscript n is the number of moles of oxyalkylene groups added and is 0 to 100. In terms of affinity for water treatment membranes, n is preferably 0 to 50, more preferably 0 to 20, still more preferably 0 to 5.

A monomer forming the structural unit (I) is preferably a monomer represented by the following formula (3):

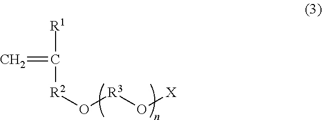

wherein all of R¹, R², R³, X, and n are the same as those in the formula (1).

An example of the monomer represented by the formula (1) is glycerol mono(meth)acrylate.

In the polymer, the proportion of the structural unit (I) represented by the formula (1) is preferably 5 to 99 mol % based on 100 mol % of all structural units. It is more preferably 10 to 90 mol %, still more preferably 15 to 85 mol %, particularly preferably 20 to 50 mol %.

<Structural Unit (II) Derived from Carboxy Group-Containing Monomer>

The polymer of the present invention contains a structural unit derived from a carboxy group-containing monomer. In the present disclosure, the “structural unit derived from a carboxy group-containing monomer” refers to a structural unit having a structure in which at least one carbon-carbon double bond in the carboxy group-containing monomer is replaced with a carbon-carbon single bond. For example, in the case where the carboxy group-containing monomer is acrylic acid (CH₂═CHCOOH), the structural unit derived from acrylic acid can be represented by —CH₂—CH(—COOH)—.

In the present disclosure, the structural unit derived from a carboxy group-containing monomer is not limited to a structural unit actually formed by polymerization of a carboxy group-containing monomer. The structural unit derived from a carboxy group-containing monomer may be a structural unit formed by another technique as long as the structural unit has the same structure as the structure in which at least one carbon-carbon double bond in the carboxy group-containing monomer is replaced with a carbon-carbon single bond. Similarly, a “structural unit derived from a sulfonic acid group-containing monomer” described later refers to a structural unit having a structure in which at least one carbon-carbon double bond in the sulfonic acid group-containing monomer is replaced with a carbon-carbon single bond, and a “structural unit derived from a different monomer” described later refers to a structural unit having a structure in which at least one carbon-carbon double bond in the different monomer is replaced with a carbon-carbon single bond.

The number of carbon atoms in the carboxy group-containing monomer is not limited, and is preferably 3 to 10. It is more preferably 3 to 6, still more preferably 3 to 4.

The carboxy group-containing monomer is not limited as long as it is a monomer having a structure containing a polymerizable unsaturated bond (carbon-carbon double bond) and a carboxy group. Examples include unsaturated carboxylic acid monomers such as unsaturated monocarboxylic acids (e.g., acrylic acid, methacrylic acid, α-hydroxyacrylic acid, α-hydroxymethylacrylic acid, crotonic acid); unsaturated dicarboxylic acids (e.g., maleic acid, fumaric acid, itaconic acid, 2-methyleneglutaric acid); and salts thereof.

Non-limiting examples of the salts include metal salts of carboxylic acids, ammonium salts of carboxylic acids, and organic amine salts of carboxylic acids. The salts of carboxylic acids are preferably alkali metal salts of carboxylic acids, such as potassium carboxylate and sodium carboxylate; ammonium carboxylate; and quaternary amine salts of carboxylic acids.

These may be used alone or in combination of two or more.

In the copolymer, the proportion of the structural unit derived from a carboxy group-containing monomer is preferably 1 to 95 mol % based on 100 mol % of all structural units. It is more preferably 30 to 90 mol %, still more preferably 50 to 85 mol %, particularly preferably 60 to 80 mol %.

<Structural Unit Derived from Sulfonic Acid Group-Containing Monomer>

The sulfonic acid group-containing monomer is not limited as long as it is a monomer having a structure containing a polymerizable unsaturated bond (carbon-carbon double bond) and a sulfonic acid group. Preferably, the sulfonic acid group-containing monomer is one having 2 to 10 carbon atoms. The sulfonic acid group-containing monomer is more preferably one having 2 to 7 carbon atoms, still more preferably one having 3 to 6 carbon atoms.

Examples of the sulfonic acid group-containing monomer include unsaturated sulfonic acid monomers such as sulfonic acid group-containing monomers (e.g., 3-allyloxy-2-hydroxypropanesulfonic acid, 2-acrylamido-2-methylpropanesulfonic acid, styrenesulfonic acid, vinylsulfonic acid) and salts thereof.

Non-limiting examples of the salts include metal salts of sulfonic acids, ammonium salts of sulfonic acids, and organic amine salts of sulfonic acids. The salts of sulfonic acids are preferably alkali metal salts of sulfonic acids, such as potassium sulfonate and sodium sulfonate; ammonium sulfonate; and quaternary amine salts of sulfonic acids.

These may be used alone or in combination of two or more.

In the copolymer, the proportion of the structural unit derived from a sulfonic acid group-containing monomer is preferably 1 to 50 mol % based on 100 mol % of all structural units. It is more preferably 1 to 40 mol %, still more preferably 1 to 30 mol %. By changing the type and amount of the structural unit, the amount of the polymer adhered to a membrane can be adjusted as appropriate.

<Structural Unit Derived from Different Monomer>

The polymer of the present disclosure may contain one or more structural units derived from a different monomer (hereinafter also referred to as “a structural unit derived from a different monomer”) other than the structural unit (I) represented by the formula (1), the structural unit (II) derived from a carboxy group-containing monomer, and the structural unit derived from a sulfonic acid group-containing monomer.

The structural unit derived from a different monomer is a constituent unit in which the carbon-carbon double bond (C═C) of the ethylenically unsaturated monomer(s) is replaced by a carbon-carbon single bond (C—C) and the single bond forms bonds with the adjacent constituent units. As long as the structural unit derived from a different monomer has a structure corresponding to such a constituent unit, the structural unit derived from a different monomer is not limited to one having a structure actually formed by replacing the carbon-carbon double bond of the monomer by a carbon-carbon single bond.

Specific examples of the different monomer include hydroxy group-containing alkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and α-hydroxymethylethyl (meth)acrylate; alkyl (meth)acrylates which are C1-C18 alkyl esters of (meth)acrylic acid, such as methyl (meth)acrylate, ethyl (meth)acrylate, butyl (meth)acrylate, cyclohexyl (meth)acrylate, and lauryl (meth)acrylate; amino group-containing acrylates such as dimethylaminoethyl (meth)acrylate and quaternized compounds thereof; amide group-containing monomers such as (meth)acrylamide, dimethylacrylamide, and isopropylacrylamide; vinyl esters such as vinyl acetate; alkenes such as ethylene and propylene; aromatic vinyl monomers such as styrene; maleimide and maleimide derivatives such as phenylmaleimide and cyclohexylmaleimide; nitrile group-containing vinyl monomers such as (meth)acrylonitrile; aldehyde group-containing vinyl monomers such as (meth)acrolein; alkyl vinyl ethers such as methyl vinyl ether, ethyl vinyl ether, and butyl vinyl ether; functional group-containing monomers other than the aforementioned monomers, such as vinyl chloride, vinylidene chloride, allyl alcohol, and vinylpyrrolidone; and polyalkylene glycol chain-containing monomers such as polyalkylene glycol (meth)acrylate, monoalkoxy polyalkylene glycol (meth)acrylate, and a monomer having a structure in which 1 to 300 mol of an alkylene oxide is added to an unsaturated alcohol such as vinyl alcohol, (meth)allyl alcohol, or isoprenol.

These different monomers may be used alone or in combination of two or more.

In the polymer, the proportion of the structural unit derived from a different monomer is preferably 40 mol % or less based on 100 mol % of all structural units. It is more preferably 30 mol % or less, still more preferably 20 mol % or less. By changing the type and amount of the structural unit, the amount of the polymer adhered to a membrane can be adjusted as appropriate.

The polymer preferably has a weight average molecular weight of 3,000 to 1,000,000. The polymer having such a molecular weight can impart high antifouling ability to a membrane. The weight average molecular weight is more preferably 4,000 to 200,000, still more preferably 5,000 to 100,000, even more preferably 7,000 to 60,000.

The weight average molecular weight of the polymer may be measured with gel permeation chromatography (GPC) by the method described in the Examples described below.

### <Method of Producing Water Treatment Chemical>

The polymer may be produced by any method as long as the polymer is produced from a monomer represented by the formula (3), a carboxy group-containing monomer, an optional sulfonic acid group-containing monomer, and an optional different monomer. The polymerization reaction may be radical polymerization, cationic polymerization, or anionic polymerization. The polymerization reaction may be either photopolymerization or thermal polymerization.

The polymerization reaction for producing the polymer is preferably performed using a polymerization initiator. The polymerization initiator may be selected from a radical polymerization initiator, a cationic polymerization initiator, and an anionic polymerization initiator depending on the type of the polymerization reaction. The polymerization initiator may be a commonly used one.

The total amount of the polymerization initiator used is not limited as long as it can initiate copolymerization of the monomers. The total amount of the polymerization initiator is preferably 15 g or less per mole of the total amount of all monomer components. The total amount of the polymerization initiator is more preferably 1 to 12 g.

The polymerization temperature is appropriately determined depending on the polymerization method, solvent, polymerization initiator, or the like, used. The polymerization temperature is preferably 25° C. to 200° C. It is more preferably 50° C. to 150° C., still more preferably 60° C. to 120° C., particularly preferably 70° C. to 100° C. When the polymerization temperature is lower than 25° C., a polymer having too high a weight average molecular weight may be obtained or the amount of impurities produced may increase.

The polymerization time is preferably, but is not limited to, 30 to 420 minutes, more preferably 45 to 390 minutes, still more preferably 60 to 360 minutes, particularly preferably 90 to 300 minutes.

The water treatment chemical of the present invention may contain a different component as long as the water treatment chemical contains the above polymer.

Examples of the different component include pH stabilizers such as phosphates, antimicrobial components such as sodium hypochlorite, and solvents.

For example, the solvents are preferably water-soluble solvents, and specific examples include lower alcohols such as methanol, ethanol, and propanol, acetone, and water.

The water treatment chemical of the present invention may contain one or more of the different components.

The amount of the different component(s) in the water treatment chemical of the present invention is preferably, but not limited to, 40% by mass or less relative to 100% by mass of the polymer in the water treatment chemical. The amount of the different component(s) is more preferably 20% by mass or less.

The water treatment chemical of the present invention may be used in the form of an aqueous solution. In this case, the concentration of the polymer in the aqueous solution is preferably, but not limited to, 0.1 to 50,000 mg/L. The aqueous solution having a concentration within the above range has a viscosity that enables easy handling of the aqueous solution. Further, such an aqueous solution can prevent inefficiency caused by too long a processing time for imparting anti-fouling ability to a water treatment membrane. The concentration of the aqueous solution is more preferably 0.1 to 20,000 mg/L, still more preferably 0.1 to 10,000 mg/L.

The aqueous solution of the water treatment chemical of the present invention may be prepared using any water. The water is preferably water with a low ion load such as demineralized water.

When a water treatment membrane is treated with the water treatment chemical of the present invention, the water treatment chemical may be added to water to be treated to prepare an aqueous solution and a water treatment membrane is treated with the aqueous solution.

The water treatment chemical of the present invention can be used as a flocculant, a corrosion inhibitor, an antifoaming agent, or an antifouling ability-imparting agent, for example, in water treatment.

The water treatment chemical of the present invention can exhibit a function of preventing or reducing adsorption of foulants to a water treatment membrane (sometimes referred to as antifouling ability).

The foulants herein refer to water permeation inhibiting components that contaminate a water treatment membrane and causes fouling. Non-limiting examples of the foulants include organic substances (e.g., polysaccharides, proteins, humic substances, fulvic acid), microorganisms, inorganic salts, colloids, and small solids.

The water treatment chemical of the present invention tends to easily prevent or reduce adsorption of organic substances and microorganisms among foulants to a water treatment membrane.

The water treatment chemical of the present disclosure can impart excellent antifouling ability to a water treatment membrane.

### (Water Treatment Membrane of the Present Disclosure)

### <Water Treatment Membrane>

The water treatment membrane of the present disclosure only has to be a membrane containing a water treatment chemical. An example of the water treatment membrane of the present disclosure is a water treatment membrane including a membrane that can be used for various types of water treatments and a water treatment chemical.

The membrane that can be used for water treatment is preferably, but not limited to, a porous filtration membrane such as a microfiltration membrane, an ultrafiltration membrane, a nanofiltration membrane, or a reverse osmosis membrane (RO membrane).

The porous filtration membrane may be made of any material, and examples include: polysulfone (PS); polyethersulfone (PES); cellulose acetate (CA); polyacrylonitrile (PAN); polyolefins such as polyethylene (PE) and polypropylene (PP); fluorine-based materials such as polyvinylidene fluoride (PVDF) and tetrafluoroethylene (PTFE); polyimide (PI); and polyamide (PA). More preferred are PS, PES, PVDF, and PA, and still more preferred is PA. Such porous filtration membranes tend to have a high affinity with the water treatment chemical of the present disclosure and can stably hold the water treatment agent.

The water treatment membrane of the present disclosure may consist of only one porous filtration membrane material and the water treatment chemical, or may consist of a multilayer membrane including two or more porous filtration membrane materials and the water treatment chemical. When the water treatment membrane of the present disclosure is a multilayer membrane, a surface layer constituting the surface of the membrane is preferably made of PS, PES, PVDF, or PA. More preferably, the surface layer of the membrane is made of PA.

To reduce the amount of foulants adsorbed to the water treatment membrane of the present disclosure, the water treatment membrane preferably contains at least part of the water treatment chemical on the surface of the water treatment membrane.

In the water treatment membrane of the present disclosure, the water treatment chemical preferably forms a layer on the surface of the water treatment membrane. When the water treatment membrane is a multilayer membrane, the water treatment chemical preferably forms a layer on a surface layer of the multilayer membrane. The water treatment chemical may form a single layer or a multilayer structure.

When the water treatment membrane of the present disclosure is a multilayer membrane, the amount of the water treatment chemical adhered to the surface layer of the water treatment membrane is preferably 1% by mass or more, more preferably 5% by mass or more, still more preferably 8% by mass or more, relative to the total amount of the surface layer of the water treatment membrane. The amount is preferably 90% by mass or less, more preferably 70% by mass or less, still more preferably 50% by mass or less at a partitioned portion. If the ratio of the water treatment chemical relative to the total amount of the surface layer of the water treatment membrane is too low, the antifouling ability will be insufficient. If the ratio of the water treatment chemical is too high, the permeate water flux will decrease.

When the water treatment membrane of the present disclosure is a single-layer membrane, the ratio of the water treatment chemical adhered to the single-layer water treatment membrane relative to the total amount of the membrane is preferably the same as the above-described ratio.

The amount of water treatment chemical adhered to the single-layer water treatment membrane of the present disclosure and the amount of water treatment chemical adhered to the surface layer of the multilayer water treatment membrane of the present disclosure can be calculated by a known method. For example, the amounts can be determined by X-ray electron spectroscopy (ESCA).

When determining the amount of water treatment chemical adhered to the surface layer of the water treatment membrane of the present disclosure by ESCA, the amount can be calculated from the proportions of elements detected in the surface layer of the water treatment membrane by ESCA and the proportions of elements detected in the surface layer of a membrane that can be used for water treatment.

The following describes a specific example of analysis by ESCA.

The C1s, O1s, N1s, F1s, S2p, and Cl2p narrow spectra, for example, of each of the elements detected in the wide spectrum are measured using an X-ray photoelectron spectrometer AXIS-NOVA (Shimadzu Corporation) with an X-ray source of monochromatic Al-Kα, an output of 10 mA, 10 kV, and a spectroscopic system with a pass energy of 40 eV. Using each of the obtained photoelectron peaks of the elements, the background is removed by the Shirley method. In the spectrum free of the background, the area of the photoelectron peak of each element is determined. The peak area of the element is multiplied by the corresponding relative sensitivity factor provided by the manufacturer of the device. Using the sum of the values obtained by multiplying each of the peak areas of the elements by the corresponding relative sensitivity factor, and the values obtained by multiplying each of the peak areas of the elements by the corresponding relative sensitivity factor, the difference in concentration of each element between before and after addition of the water treatment chemical can be calculated. Here, the elements used in the calculation may be any element contained in the porous filtration membrane and/or water treatment chemical as detected by ESCA. Regarding the priority of elements used for calculation, nitrogen (N), sulfur (S), carbon (C), oxygen (O), chlorine (Cl), and fluorine (F) are used in this order.

For example, when the detected element is nitrogen (N), the following equations (1) and (2) can be used for calculation.

Nitrogen atom concentration (%)=(100×Value obtained by multiplying peak area of N1s by corresponding relative sensitivity factor)/(Sum of values obtained by multiplying each of peak areas of elements by corresponding relative sensitivity factor) (Formula (1))

Water treatment chemical content (%)=100×(Nitrogen atom concentration (%) of porous filtration membrane−Nitrogen atom concentration (%) of water treatment membrane)/(Nitrogen atom concentration of porous filtration membrane (%)−Nitrogen atom concentration of water treatment chemical (%)) (Formula (2))

The water treatment membrane of the present disclosure may contain a different component.

### <Method of Producing Water Treatment Membrane>

The water treatment membrane of the present disclosure can exhibit antifouling ability by incorporating a water treatment chemical to the membrane.

The water treatment membrane of the present invention may be a membrane prepared by incorporating a water treatment chemical into a membrane that can be used for water treatment such as a porous filtration membrane.

The water treatment chemical may be incorporated into a membrane that can be used for water treatment such as a porous filtration membrane by any known method. Examples include: a method including mixing a raw material of a membrane that can be used for water treatment with the water treatment chemical of the present invention and forming a water treatment membrane from the mixture; a method of bonding a polymer contained in the water treatment chemical of the present invention to a surface of a raw material resin of a membrane that can be used for water treatment by graft polymerization or the like; a method of coating a membrane that can be used for water treatment with the water treatment chemical of the present invention; and a method of bringing an aqueous solution of the water treatment chemical of the present invention into contact with a membrane that can be used for water treatment.

Of the above various types of the methods of treating a water treatment membrane with the water treatment chemical, a preferred method of incorporating the water treatment chemical into a water treatment membrane is bringing an aqueous solution of the water treatment chemical of the present invention into contact with a membrane that can be used for water treatment. This method can simultaneously achieve water treatment with a water treatment apparatus and impartment of antifouling ability to the water treatment membrane. Thus, the method enables the easiest production of the water treatment membrane of the present invention.

The method of bringing an aqueous solution of the water treatment chemical of the present invention into contact with a membrane that can be used for water treatment may be any method that allows the membrane to have antifouling ability. The method is preferably a method of passing under pressure the aqueous solution of the water treatment chemical through a membrane that can be used for water treatment.

When the aqueous solution of the water treatment chemical is passed through under pressure a membrane that can be used for water treatment, the aqueous solution of the water treatment chemical may be passed through under pressure a membrane that can be used for water treatment provided in a water treatment apparatus, or alternatively, the aqueous solution of the water treatment chemical may be passed through under pressure a membrane that can be used for water treatment provided separately from a water treatment apparatus. When antifouling ability is imparted to a membrane that can be used for water treatment provided in a water treatment apparatus, the water treatment chemical of the present invention may be added to water to be treated during operation of the water treatment apparatus to simultaneously perform water treatment and impartment of antifouling ability, or alternatively, only impartment of antifouling ability may be performed without water treatment.

When the aqueous solution of the water treatment chemical is passed through under pressure a membrane that can be used for water treatment, the pressure is not limited as long as antifouling ability is imparted and is preferably 0.1 to 12 MPa. The flux of the membrane when the solution is passed therethrough is preferably, but not limited to, about 0.1 to 15 m³/m²/day.

When the solution is passed under the above-described conditions, antifouling ability can be sufficiently imparted, while too much decrease in flux is prevented.

The treatment by passing under pressure the aqueous solution of the water treatment chemical through a membrane that can be used for water treatment may be performed for any duration. To prevent too much decrease in flux and to sufficiently impart antifouling ability, the duration is preferably 0.5 to 1,000 hours. The duration is more preferably 1 to 300 hours.

The treatment by passing under pressure the aqueous solution of the water treatment chemical through a membrane that can be used for water treatment may be performed at any temperature. To prevent too much decrease in flux and to prevent degradation of the water treatment membrane, the temperature is preferably 5° C. to 60° C. The temperature is more preferably 10° C. to 50° C.

### <Method of Using Water Treatment Membrane>

When the water treatment membrane of the present disclosure is used for water treatment over a long period of time, foulants may gradually be adsorbed to the water treatment membrane, resulting in a decrease in water permeability. In this case, foulants adsorbed on the membrane may be removed.

Foulants adsorbed on the water treatment membrane of the present disclosure may be removed by any method and can be more effectively removed by cleaning by mechanical stripping and/or chemical cleaning.

The water treatment membrane of the present disclosure can exhibit excellent antifouling ability over a long period of time, and has good water permeability and good water permeability retention.

The water treatment membrane of the present disclosure can be used in various types of water treatments. For example, a water treatment membrane prepared by imparting antifouling ability to an RO membrane can suitably be used in various types of water treatment systems such as an ultrapure water producing system and a wastewater collection system.

### EXAMPLES

The following description is offered to demonstrate the present invention based on examples of the present invention. The examples should not be construed as limiting the present invention. Unless otherwise mentioned, the term “part(s)” means “part(s) by weight” and “%” means “% by mass”.

### Production of Water Treatment Chemical

### Example 1

A glass reaction vessel was charged with 222 parts by mass of pure water, 4.8 parts by mass of glycerol monomethacrylate (hereinafter also referred to as GLMM), and 10.8 parts by mass of an 80% by mass aqueous acrylic acid solution (hereinafter also referred to as 80% by mass AA) and was sealed. With stirring, the temperature was raised to 80° C. Subsequently, with stirring, to the polymerization reaction system in a constant state at 80° C. were added 10.0 parts by mass of a 0.057% by mass Mohr's salt aqueous solution, 10.0 parts by mass of a 7.5% by mass aqueous sodium bisulfite solution (hereinafter also referred to as 7.5% by mass SBS), and 10.0 parts by mass of a 4.5% by mass aqueous sodium persulfate solution (hereinafter referred to as 4.5% by mass NaPS) in this order. The vessel was sealed, and solution polymerization was allowed to proceed for three hours. Thus, a water treatment chemical (1) containing a polymer having a structural unit (I) represented by the formula (1) and a structural unit (II) derived from a carboxy group-containing monomer was obtained. The polymer had a weight average molecular weight (Mw) of 10,000, as measured by the following technique.

### Comparative Example 1

A glass reaction vessel was charged with 223 parts by mass of pure water and 12.8 parts by mass of GLMM and was sealed. With stirring, the temperature was raised to 80° C. Subsequently, with stirring, to the polymerization reaction system in a constant state at 80° C. were added 10.0 parts by mass of a 4.0% by mass aqueous sodium bisulfite solution (hereinafter also referred to as 4.0% by mass SBS) and 10.0 parts by mass of a 2.4% by mass aqueous sodium persulfate solution (hereinafter referred to as 2.4% by mass NaPS) in this order. The vessel was sealed, and solution polymerization was allowed to proceed for three hours. Thus, a water treatment chemical (2) containing a polymer was obtained. The polymer had a weight average molecular weight (Mw) of 30,000, as measured by the following technique.

### Example 2

A glass reaction vessel was charged with 249 parts by mass of pure water, 12.8 parts by mass of GLMM, and 1.8 parts by mass of 80% by mass AA and was sealed. With stirring, the temperature was raised to 80° C. Subsequently, with stirring, to the polymerization reaction system in a constant state at 80° C. were added 10.0 parts by mass of a 5.0% by mass aqueous sodium bisulfite solution (hereinafter also referred to as 5.0% by mass SBS) and 10.0 parts by mass of a 3.0% by mass aqueous sodium persulfate solution (hereinafter referred to as 3.0% by mass NaPS) in this order. The vessel was sealed, and solution polymerization was allowed to proceed for three hours. Thus, a water treatment chemical (3) containing a polymer having a structural unit (I) represented by the formula (1) and a structural unit (II) derived from a carboxy group-containing monomer was obtained. The polymer had a weight average molecular weight (Mw) of 30,000, as measured by the following technique.

### <Weight Average Molecular Weight>

Apparatus: HLC-8320GPC (Tosoh Corporation)
Detector: RI
Column: TSKgel α-M, α-2500, PWXL (Tosoh Corporation)
Column temperature: 40° C.
Flow rate: 0.5 ml/min
Calibration curve: POLYETHYLENE GLYCOL STANDARD (Sowa Kagaku Co., Ltd.)
Eluent: 0.2 M aqueous sodium acetate solution/acetonitrile=80/20 by vol %

TABLE 1

| | Water | Polymer | | |
|---|---|---|---|---|
| | treatment | Composition (mol %) | | |
| | chemical | GLMM | AA | Mw |
| Example 1 | (1) | 20 | 80 | 10,000 |
| Comparative | (2) | 100 | 0 | 30,000 |
| Example 1 | | | | |
| Example 2 | (3) | 80 | 20 | 30,000 |

### Production of Water Treatment Membrane

### Example 3

The water treatment chemical (1) synthesized in Example 1 was diluted with pure water to prepare an aqueous solution containing 1 wt % of the polymer. A reverse osmosis membrane (NITTO DENKO CORPORATION, ESPA2) was immersed in the solution for 16 hours so that a surface of the membrane was modified with the polymer. Thus, a water treatment membrane (1) was prepared. The antifouling ability of the modified water treatment membrane (1) was evaluated by the following technique. The results are shown in Table 2.

### (Evaluation of Water Treatment Membrane)

### <Evaluation of Antifouling Ability>

### (Initial Water Permeability)

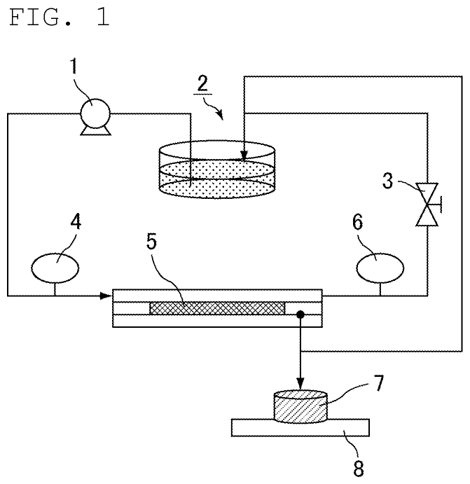

With an apparatus, shown in FIG. 1, including a membrane modified with a synthesized polymer, ion exchange water was passed through the membrane under a pressure of 0.75 MPa, and then, a 0.05% by mass aqueous sodium chloride solution was passed through the membrane under a pressure of 0.75 MPa. The flux was measured to obtain an initial permeate water flux.

### (Water Permeability Retention)

In addition, a 0.05% by mass aqueous sodium chloride solution containing 0.01% by mass bovine serum albumin as a foulant was passed through the membrane under a pressure of 0.75 MPa. After four hours, the flux was measured for calculation of water permeability retention. The water permeability retention is calculated using the following equation. Water permeability retention (%)=100×Permeate water flux after four hours/Initial permeate water flux

### Example 4

A water treatment membrane (2) was prepared as in Example 3, except that the water treatment chemical (1) synthesized in Example 1 was diluted with pure water to prepare an aqueous solution containing 0.1 wt % of the polymer. The antifouling ability of the water treatment membrane (2) was evaluated as in Example 3. The results are shown in Table 2.

### Comparative Example 2

A water treatment membrane (3) not modified with a polymer was subjected to evaluation of antifouling ability as in Example 3. The results are shown in Table 2.

### Comparative Example 3

A water treatment membrane (4) was prepared as in Example 3, except that the water treatment chemical (2) synthesized in Comparative Example 1 was used. The antifouling ability of the water treatment membrane (4) was evaluated as in Example 3. The results are shown in Table 2.

### Example 5

The water treatment chemical (3) synthesized in Example 2 was diluted with pure water to prepare an aqueous solution containing 0.1 wt % of the polymer. A reverse osmosis membrane (NITTO DENKO CORPORATION, ESPA2) was immersed in the solution for 16 hours so that a surface of the membrane was modified with the polymer. Thus, a water treatment membrane (5) was prepared. The antifouling ability of the modified water treatment membrane (5) was evaluated as in Example 3. The results are shown in Table 2.

TABLE 2

| | | | Initial | Water |
|---|---|---|---|---|
| | Water | Water | water | permeability |
| | treatment | treatment | permeability | retention |
| | membrane | chemical | (LMH) | (%) |
| Example 3 | (1) | (1) | 31 | >9 |
| Example 4 | (2) | (1) | 39 | 93 |
| Comparative | (3) | — | 45 | 77 |
| Example 2 | | | | |
| Comparative | (4) | (2) | 26 | >9 |
| Example 3 | | | | |
| Example 5 | (5) | (3) | 36 | 90 |

The results shown in Table 2 demonstrate that the water treatment chemical of the present disclosure can impart high water permeability and excellent water permeability retention as well as antifouling function to water treatment membranes.

### REFERENCE SIGNS LIST

1: pump
2: feed liquid
3: pressure regulator
4: pressure gauge
5: reverse osmosis membrane (RO membrane)
6: pressure gauge
7: liquid that has passed through membrane (pure water)
8: scale

1. A water treatment chemical comprising a polymer that comprises:
a structural unit (I) represented by a formula (1); and
a structural unit (II) derived from a carboxy group-containing monomer,
the formula (1) being represented by the following formula: 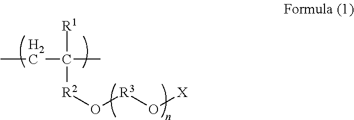
wherein R¹ is a hydrogen atom or a methyl group; R² is a direct bond, —CH₂—, —CH₂CH₂—, or —CO—; R³s are the same as or different from each other and are each a C1-C20 alkylene group; X is —CH₂CH(OH)CH₂(OH) or —CH(—CH₂OH)₂; and n is a number of moles of oxyalkylene groups added and is 0 to 100.

2. The water treatment chemical according to claim 1,
wherein the water treatment chemical is an antifouling ability-imparting agent.

3. The water treatment chemical according to claim 1, wherein R² is —CO—.

4. The water treatment chemical according to claim 1,
wherein R³s are each a C2-C3 alkylene group.

5. The water treatment chemical according to claim 1,
wherein n is 0 to 5.

6. The water treatment chemical according to claim 1,
wherein a proportion of the structural unit (I) represented by the formula (1) is 5 to 99 mol % based on 100 mol % of all structural units in the polymer.

7. The water treatment chemical according to claim 1,
wherein a proportion of the structural unit (I) represented by the formula (1) is 10 to 90 mol % based on 100 mol % of all structural units in the polymer.

8. The water treatment chemical according to claim 1,
wherein a proportion of the structural unit (I) represented by the formula (1) is 15 to 85 mol % based on 100 mol % of all structural units in the polymer.

9. The water treatment chemical according to claim 1,
wherein a proportion of the structural unit (I) represented by the formula (1) is 20 to 50 mol % based on 100 mol % of all structural units in the polymer.

10. The water treatment chemical according to claim 1,
wherein the number of carbon atoms in the carboxy group-containing monomer is 3 to 10.

11. The water treatment chemical according to claim 1,
wherein a number of carbon atoms in the carboxy group-containing monomer is 3 to 6.

12. The water treatment chemical according to claim 1,
wherein the number of carbon atoms in the carboxy group-containing monomer is 3 to 4.

13. The water treatment chemical according to claim 1,
wherein the carboxy group-containing monomer is selected from the group consisting of acrylic acid, methacrylic acid, α-hydroxyacrylic acid, α-hydroxymethylacrylic acid, crotonic acid, maleic acid, fumaric acid, itaconic acid, 2-methyleneglutaric acid, and salts thereof.

14. The water treatment chemical according to claim 1,
wherein a proportion of the structural unit derived from a carboxy group-containing monomer is 1 to 95 mol % based on 100 mol % of all structural units in the polymer.

15. The water treatment chemical according to claim 1,
wherein a proportion of the structural unit derived from a carboxy group-containing monomer is 30 to 90 mol % based on 100 mol % of all structural units in the polymer.

16. The water treatment chemical according to claim 1,
wherein a proportion of the structural unit derived from a carboxy group-containing monomer is 50 to 85 mol % based on 100 mol % of all structural units in the polymer.

17. The water treatment chemical according to claim 1,
wherein a proportion of the structural unit derived from a carboxy group-containing monomer is 60 to 80 mol % based on 100 mol % of all structural units in the polymer.

18. The water treatment chemical according to claim 1,
wherein the polymer has weight average molecular weight of 3,000 to 1,000,000.

19. A water treatment membrane comprising the water treatment chemical according to claim 1.

20. The water treatment membrane according to claim 19,
wherein the water treatment chemical forms a layer on a surface of the membrane that can be used for the water treatment.
